(19) United States
(12) Patent Application Publication
(10) Pub. No.: US 2024/0270079 A1
(43) Pub. Date: Aug. 15, 2024

(54) Method And Apparatus for Controlling Brake Torque

(71) Applicant: HYUNDAI MOBIS CO., LTD., Seoul (KR)

(72) Inventor: Jong Sung KIM, Seoul (KR)

(73) Assignee: HYUNDAI MOBIS CO., LTD., Seoul (KR)

(21) Appl. No.: 18/380,809

(22) Filed: Oct. 17, 2023

(30) Foreign Application Priority Data
Feb. 10, 2023 (KR) 10-2023-0018068

(51) Int. Cl. B60L 7/26

(52) U.S. Cl. CPC B60L 7/26; B60L 2240/423

(57) ABSTRACT

An apparatus for controlling braking torque for a vehicle, comprising: a regenerative braking apparatus generating a regenerative braking torque to rear wheels; a plurality of electro mechanical brakes (EMBs) generating a friction braking torque using an actuator; and a controller unit that controls the regenerative braking apparatus and the plurality of EMBs, distributes a front wheel friction braking torque to front wheels, and distributes a rear wheel braking torque, which is the sum of a rear wheel friction braking torque and a rear wheel regenerative braking torque, to rear wheels, wherein the plurality of EMBs is respectively provided for each wheel of the vehicle so that a different friction braking torque is generated for each wheel, and the controller unit changes a distribution ratio between the front wheel friction braking torque and the rear wheel friction braking torque.

### CROSS-REFERENCE TO RELATED APPLICATIONS

The present application claims priority to Patent Application No. 10-2023-0018068, filed on Feb. 10, 2023 in Korea, the entire contents of which are incorporated herein by reference.

### TECHNICAL FIELD

The present disclosure relates to an apparatus and method for controlling braking torque. More specifically, it relates to an apparatus and method for controlling braking torque capable of changing a distribution ratio of friction braking torques respectively distributed to front and rear wheels based on a required deceleration when braking torque is distributed to wheels of a rear-wheel driving electric vehicle.

### BACKGROUND

The content described in this section only provides background information for the present disclosure and does not make up prior art.

Braking torque acting on a vehicle is largely divided into a friction braking torque and a regenerative braking torque. The friction braking torque is generated by a friction braking apparatus directly pressurizing a wheel of a vehicle. For example, a brake pad pressurizes against a disc to stop a wheel from rotating. The regenerative braking torque is generated by an electric driving motor during regenerative braking. The regenerative braking is a braking method where braking force is obtained by converting rotational kinetic energy of a driving motor into electrical energy. Because the converted electrical energy can be stored in a battery, the regenerative braking improves fuel economy of electric cars.

In general, the regenerative braking is applied to electric vehicles to enhance fuel economy of electric cars. The fuel economy refers to the distance traveled per 1 kWh by an electric vehicle. With regard to fuel economy, it is advantageous to apply the regenerative braking, but it is not common to apply only the regenerative braking. Instead, it is generally applied together with friction braking depending on circumstances.

The majority of electric vehicles are rear-wheel driving vehicles, and the rear-wheel driving vehicles have the advantage of providing a comfortable ride and excellent quietness and providing sufficient grip when starting, allowing the vehicles to move forward stably. Because the regenerative braking is performed by an electric driving motor, it can be applied only to rear wheels of a rear-wheel driving vehicle.

FIG. 1 is a graph showing a conventional distribution of braking torque.

FIG. 2 is a graph showing an ideal curve of braking torque.

Referring to FIGS. 1 and 2, when a conventional electric vehicle simultaneously performs a friction braking and a regenerative braking, a friction braking apparatus is not capable of changing a distribution ratio of friction braking torques. Specifically, a distribution ratio between a front wheel friction braking torque and a rear wheel friction braking torque respectively acting on front and rear wheels has a constant value. Therefore, it is impossible to change a distribution ratio based on a required deceleration. When the friction braking and the regenerative braking are performed simultaneously, the friction braking apparatus increases or decreases torques respectively applied to front and rear wheels of the vehicle based on a predetermined distribution ratio between the front wheel friction braking torque and the rear wheel friction braking torque. The dashed line in FIG. 1 is a distribution line between a front wheel friction braking torque and a rear wheel friction braking torque when there is no rear wheel regenerative braking torque.

In the case of a rear-wheel driving electric vehicle, regenerative braking can be applied only to the rear wheels, so, during the regenerative braking, a distribution ratio of braking torques respectively acting on the front and rear wheels of the vehicle deviates from an ideal braking torque curve. This is because only a friction braking torque is applied to the front wheels, and the friction braking torque and a regenerative braking torque are simultaneously applied to the rear wheels.

A distribution ratio outside an ideal braking torque curve is not necessarily a problem. When a friction coefficient of a road surface is sufficient and a required deceleration is not high, the likelihood of wheels being locked is low. Accordingly, a distribution ratio of friction braking torques respectively acting on front and rear wheels deviating from an ideal ratio does not generally cause safety issues, and, as long as safety is not compromised, it is more economical to apply regenerative braking as well. In contrast, when a required deceleration is not high but a friction coefficient of a road surface is not sufficient, such as on an icy road, or when a high deceleration is required, it should be noted that a high distribution ratio of a regenerative braking torque may jeopardize safety.

When a distribution ratio of a regenerative braking torque is recklessly increased, safety issues may be caused, but fuel economy rises as the distribution ratio of the regenerative braking torque increases. Therefore, a braking apparatus capable of adjusting a distribution ratio of a regenerative braking torque according to circumstances is required. Specifically, when a friction braking and a regenerative braking are simultaneously applied to a conventional rear-wheel driving electric vehicle, it is not possible to arbitrarily change a distribution ratio of friction braking torques respectively acting on the front and rear wheels, so that it is not possible to freely increase a distribution ratio of a regenerative braking torque applied to the rear wheels. This is because, when both a distribution ratio of a regenerative braking torque and a required deceleration are high or when a required deceleration is low but a friction coefficient of a road surface is low, steering and braking may not be performed as desired by a driver as a braking performance is deteriorated so that the driver's safety may not be guaranteed. However, when a distribution ratio of a regenerative braking torque is limited below a certain level, it may not be economically efficient. Because there is no major safety problem when a friction coefficient of a road surface is high and a required deceleration is low, it is economical to boost fuel economy by increasing a distribution ratio of a regenerative braking torque.

Therefore, there is a need for a braking apparatus capable of changing a distribution ratio of friction braking torques of front and rear wheels based on road surface conditions, a required deceleration, driving conditions, etc. and increasing or decreasing a distribution ratio of a regenerative braking torque accordingly.

### SUMMARY

Accordingly, the major purpose of the present disclosure is to provide a method and an apparatus for controlling braking torque for changing a distribution ratio of friction braking torques respectively acting on front and rear wheels to improve fuel efficiency of a rear-wheel driving electric vehicle and to increase a distribution ratio of a regenerative braking torque.

As described above, according to an embodiment of the present disclosure, it may be possible for the apparatus for controlling braking torque to change a distribution ratio of friction braking torques respectively acting on front and rear wheels depending on circumstances.

In addition, it may be possible to increase or decrease a distribution ratio of a regenerative braking torque depending on circumstances, enhancing fuel efficiency.

### BRIEF DESCRIPTION OF THE DRAWINGS

FIG. 1 is a graph showing a conventional distribution of braking torque.

FIG. 2 is a graph showing an ideal curve of braking torque.

FIG. 3 is a block diagram of functions of an apparatus for controlling braking torque according to an embodiment of the present disclosure.

FIG. 4 shows an amplitude of a rear wheel friction braking torque expected when a controller unit performs wheel lock prevention control according to an embodiment of the present disclosure.

FIG. 5 is a graph showing braking torque with respect to a required deceleration according to an embodiment of the present disclosure.

FIG. 6 is a graph showing braking torque with respect to a required deceleration according to an embodiment of the present disclosure.

FIG. 7 is a graph showing braking torque with respect to a required deceleration according to an embodiment of the present disclosure.

FIG. 8 is a graph showing how braking torque changes over time when the controller unit 100 starts the wheel lock prevention control according to an embodiment of the present disclosure.

FIG. 9 is a flowchart of a method of controlling braking torque by an apparatus for controlling braking torque according to an embodiment of the present disclosure.

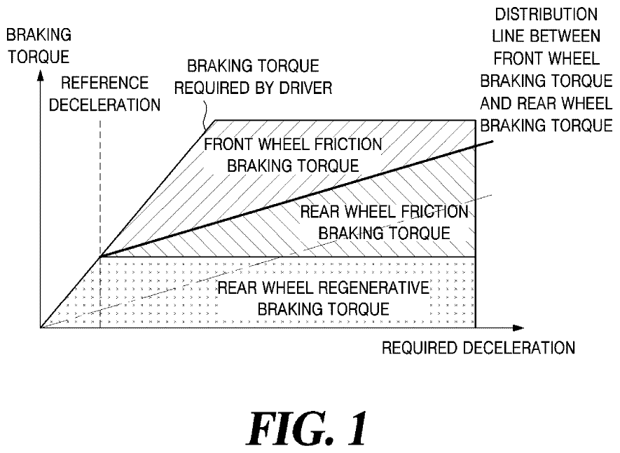

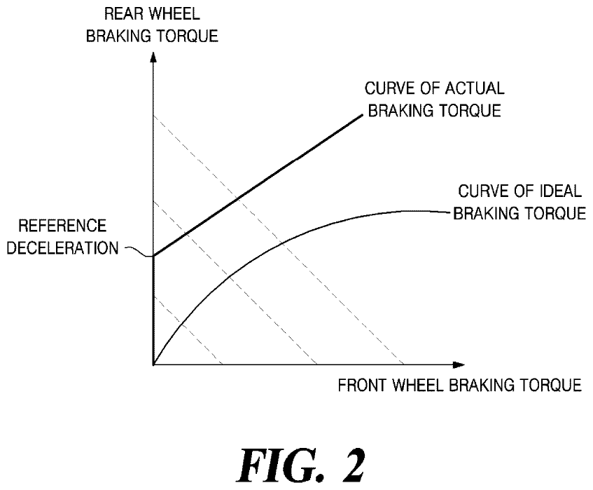

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

Each element of the apparatus or method in accordance with the present invention may be implemented in hardware or software, or a combination of hardware and software. The functions of the respective elements may be implemented in software, and a microprocessor may be implemented to execute the software functions corresponding to the respective elements.

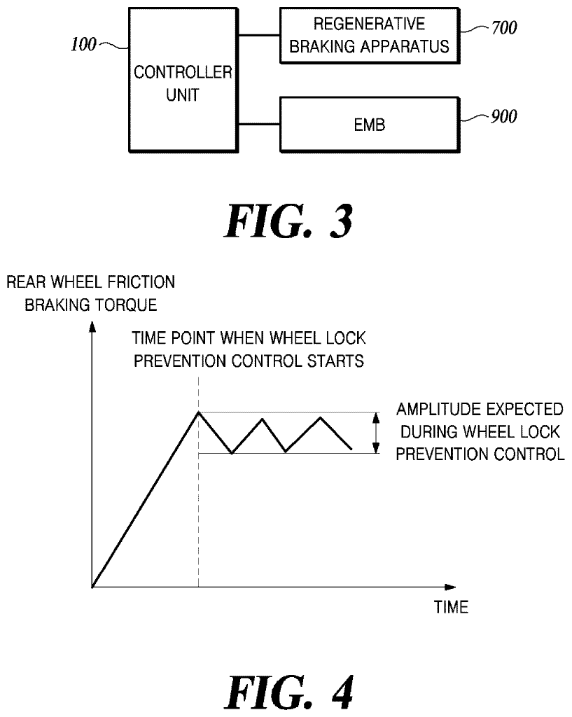

FIG. 3 is a block diagram of functions of an apparatus for controlling braking torque according to an embodiment of the present disclosure.

Referring to FIG. 3, an apparatus for controlling braking torque 1 may include all or some of a regenerative braking apparatus 700, a plurality of electro mechanical brakes (EMBs) 900, and a controller unit 100.

The regenerative braking apparatus 700 may perform regenerative braking by converting kinetic energy of a driving motor (not shown) into electrical energy according to a command of the controller unit 100. When the regenerative braking is performed, rear wheel regenerative braking torque may be generated, causing braking effect. Furthermore, it may also be possible to increase fuel economy of electric cars by storing the converted electric energy in a battery. Most electric vehicles are rear-wheel driving vehicles, and, because the regenerative braking may be carried out by an electric driving motor, the regenerative braking may be applied only to rear wheels of rear-wheel driving electric vehicles.

The EMB 900 may be a device that generates friction braking torque by the action of an actuator (not shown). The EMB 900 may have a fast response speed by not using hydraulic pressure and may be more environmentally friendly than a hydraulic brake (not shown). The EMB 900 may generate friction braking torque according to the command of the controller unit 100, and may repeatedly change the friction braking torque according to the command of the controller unit 100 to prevent the wheels from locking when the controller unit 100 starts wheel lock prevention control. According to an embodiment of the present disclosure, the apparatus for controlling braking torque 1 may include the plurality of EMBs 900, and the plurality of EMBs 900 may be respectively provided for each wheel so that a different friction braking torque may be generated for each wheel. The EMB 900 placed on the front wheel may generate front wheel friction braking torque, and the EMB 900 placed on the rear wheel may generate rear wheel friction braking torque.

Because it may be possible for the plurality of EMBs 900 to generate a friction braking torque of a different value for each wheel of a vehicle according to the command of the controller unit 100, it may be possible for the controller unit 100 to freely change a distribution ratio of friction braking torque applied to the front and rear wheels based on the driving conditions or the required deceleration.

The controller unit 100 may control the regenerative braking apparatus 700 and the plurality of EMBs 900. The controller unit 100 may distribute front wheel friction braking torque to front wheels and distribute rear wheel braking torque to rear wheels. The rear wheel braking torque may be the sum of rear wheel friction braking torque and rear wheel regenerative braking torque. Since it may be possible for the controller unit 100 to generate a friction braking torque of a different value for each wheel by controlling the EMB 900 for each wheel, it may be possible for the controller unit 100 to change a distribution ratio between front wheel friction braking torque and rear wheel friction braking torque based on the required deceleration or the driving conditions of the vehicle.

The controller unit 100 may prevent locking of wheels (not shown) when the vehicle brakes. Specifically, when braking torque acting on the wheels is excessively strong, the wheels may lock. When the wheels lock, the vehicle may slip so that braking and steering may not be performed as desired by the driver. The controller unit 100 may repeatedly change the amount of the braking torque applied to the wheels by performing the wheel lock prevention control. For example, the controller unit 100 may command the EMB 900 to repeat control for increasing and decreasing the braking torque for a short period of time. As such, the controller unit 100 may perform the wheel lock prevention control in order to enable a driver to steer the vehicle even when the vehicle is driven on a slippery road or sudden braking is performed, thereby allowing the vehicle to run safely.

FIG. 4 shows an amplitude of rear wheel friction braking torque expected when the controller unit performs the wheel lock prevention control according to an embodiment of the present disclosure.

Referring to FIG. 4, when the controller unit 100 performs the wheel lock prevention control, rear wheel friction braking torque may periodically increase and decrease. The amplitude of rear wheel friction braking torque refers to how much the rear wheel friction braking torque changes for a predetermined time when the wheel lock prevention control is performed. According to an embodiment of the present disclosure, when not performing the wheel lock prevention control, the controller unit 100 may determine a distribution ratio between front wheel friction braking torque and rear wheel friction braking torque based on the amplitude of the rear wheel friction braking torque. In detail, when the controller unit 100 performs the wheel lock prevention control, it may be possible to estimate the amplitude, which is the amount of change in the rear wheel friction braking torque by the wheel lock prevention control. When the rear wheel friction braking torque is distributed when the wheel lock prevention control is not performed, it may be distributed considering such an amplitude. In this case, the distributed rear wheel friction braking torque may have a value equal to or greater than the value of the amplitude. Since rear wheel braking torque is the sum of rear wheel friction braking torque and rear wheel regenerative braking torque, when a distribution ratio of front wheel braking torque and rear wheel braking torque has a specific value, as the rear wheel friction braking torque is reduced, the rear wheel regenerative braking torque increases as much as the rear wheel friction braking torque decreases. Therefore, the controller unit 100 may change the distribution ratio of the front wheel friction braking torque and the rear wheel friction braking torque while maintaining a predetermined distribution ratio of the front wheel and rear wheel braking torques, thereby adjusting the amount of the rear wheel regenerative braking torque and the rear wheel friction braking torque. With respect to the same required deceleration, as the amount of rear wheel regenerative braking torque increases, fuel economy of electric cars rises.

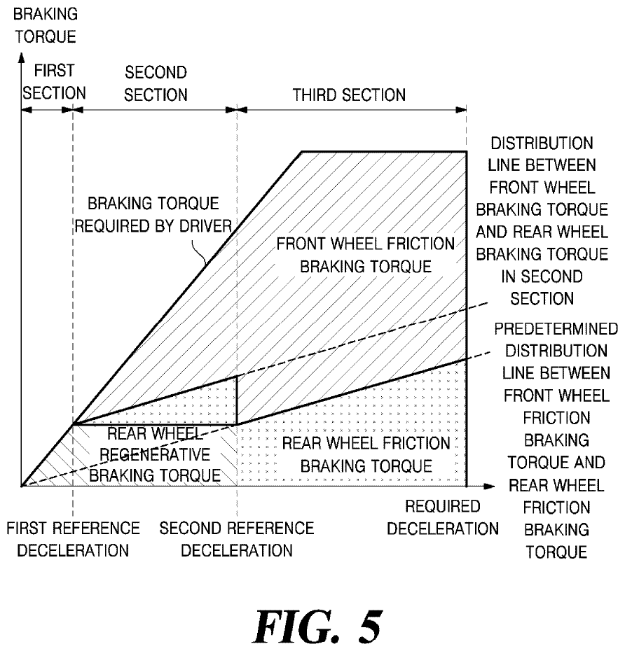

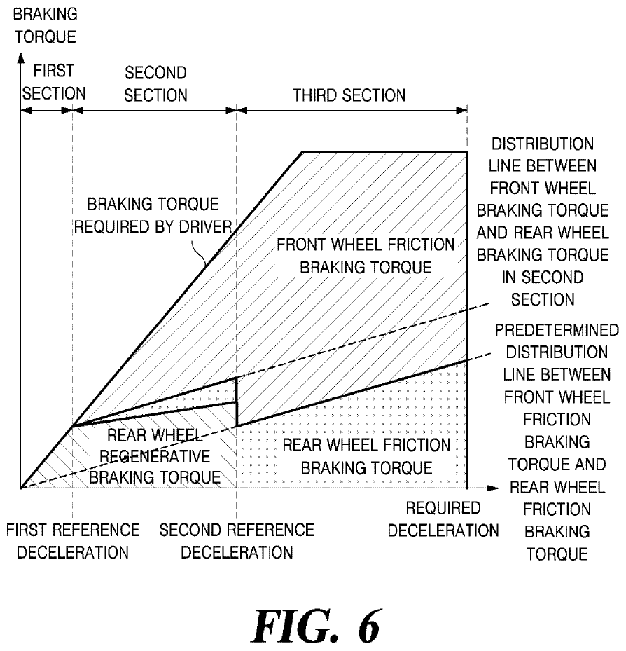

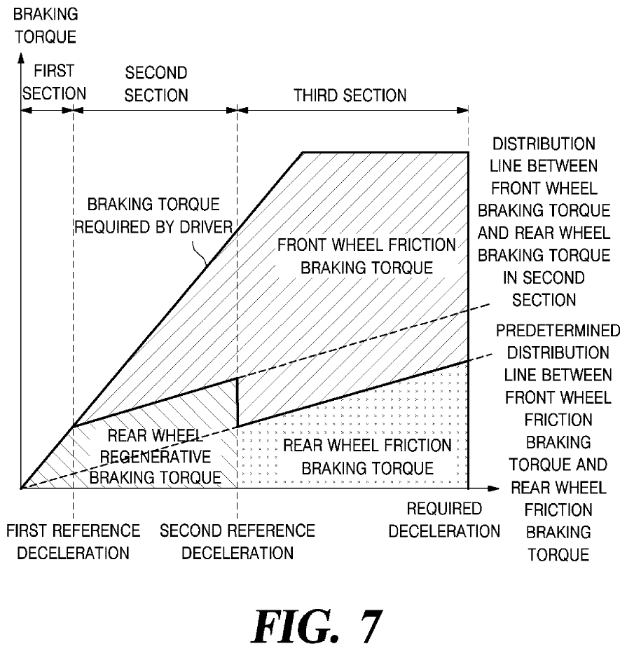

FIGS. 5 to 7 are graphs showing braking torques with respect to required deceleration according to an embodiment of the present disclosure.

Referring to FIGS. 5 to 7, in the second section, the distribution ratios of the front wheel braking torque and the rear wheel braking torque in the three graphs in FIGS. 5 to 7 may all be the same, but the distribution ratios of the front wheel friction braking torque and the rear wheel friction braking torque in the three graphs may all be different. In the second section, since the distribution ratios of the front wheel braking torques and the rear wheel braking torques in the three graphs may all be the same, the values of the rear wheel braking torques with respect to the required decelerations may all be the same, but the rear wheel regenerative braking torques and the rear wheel friction braking torques may all have different values. This is because the distribution ratios of the friction braking torques respectively acting on the front and rear wheels may all be different. In this case, fuel economy of electric cars may vary depending on the amount of the rear wheel regenerative braking torque.

In the case of a rear wheel driving electric vehicle, because regenerative braking is not applied to the front wheels, the front wheel braking torque has the same value as the front wheel friction braking torque. The rear wheel braking torque is the sum of the rear wheel friction braking torque and the rear wheel regenerative braking torque.

The apparatus for controlling braking torque 1 according to the present disclosure may change a distribution ratio between a front wheel friction braking torque and a rear wheel friction braking torque based on a required deceleration. Since it may be possible for the apparatus for controlling a braking torque 1 including the plurality of EMBs 900 to generate a friction braking torque of a different value for each wheel, the controller unit 100 may control the EMB 900 to change the distribution ratio between the front wheel friction braking torque and the rear wheel friction braking torque with respect to the required deceleration. The controller unit 100 may change the distribution ratio to distribute a greater value of friction braking torque or a less value of friction braking torque to the front wheels with respect to the same required deceleration.

The total sum of braking torque acting on a vehicle may be the sum of a front wheel friction braking torque, a rear wheel friction braking torque, and a rear wheel regenerative braking torque. Since it may be possible for the apparatus for controlling braking torque 1 to change a distribution ratio of friction braking torques respectively acting on front and rear wheels, it may be possible for the apparatus to change, based on a required deceleration, the distribution ratio of the front wheel friction braking torque, the rear wheel friction braking torque, and the rear wheel regenerative braking torque. According to an embodiment of the present disclosure, the apparatus for controlling braking torque 1 may determine a distribution ratio of a front wheel friction braking torque and a rear wheel friction braking torque and determine how much a rear wheel regenerative braking torque is to be distributed. According to an embodiment of the present disclosure, the apparatus for controlling braking torque 1 may simultaneously determine distribution ratios of a front wheel friction braking torque, a rear wheel friction braking torque, and a rear wheel regenerative braking torque.

In the graphs showing the braking torques with respect to the required decelerations, sections are divided based on the amount of the required decelerations. The first section may be a section in which a required deceleration is less than or equal to a first reference deceleration. The second section may be a section in which a required deceleration is equal to or greater than the first reference deceleration and less than or equal to a second reference deceleration. The third section may be a section in which a required deceleration is equal to or greater than the second reference deceleration.

According to an embodiment of the present disclosure, since the amount of required deceleration is small in the first section, friction braking torque may not be distributed to front and rear wheels, but only a rear wheel regenerative braking torque may be distributed. Distributing only the rear wheel regenerative braking torque may improve fuel economy of electric cars. When only the rear wheel regenerative braking torque is distributed, no braking torque may act on the front wheels, resulting in deviation from an ideal braking curve. However, since the amount of required deceleration is not large and the possibility of locking of wheels is low in the first section, it may be possible to distribute only the rear wheel regenerative braking torque, prioritizing the improvement of fuel economy of electric cars.

Since the amount of required deceleration in the second section may be greater than that in the first section, not only a rear wheel regenerative braking torque but also a friction braking torque may be distributed in the second section. Since it may be possible for the controller unit 100 to change a distribution ratio between a front wheel friction braking torque and a rear wheel friction braking torque, making it have a value other than a preset value, it may be possible for the controller unit 100 to maximize or minimize a rear wheel regenerative braking torque without changing a distribution ratio of braking torques of front and rear wheels. When a rear wheel regenerative braking torque and a friction braking torque act on a vehicle at the same time, the curve of a braking torque distributed to front and rear wheels may deviate from an ideal braking curve. Because deviation from an ideal braking curve may not necessarily cause safety issues, it may be sufficient to determine a distribution ratio of braking torques respectively acting on front and rear wheels that does not compromise safety. According to an embodiment of the present disclosure, the controller unit 100 may distribute only a rear wheel regenerative braking torque to rear wheels of a vehicle in the second section. In this case, only a front wheel friction braking torque and a rear wheel regenerative braking torque may be applied to the vehicle, and it may be possible to secure a large amount of regenerative braking, thereby improving fuel economy of electric cars. According to an embodiment of the present disclosure, the controller unit 100 may determine a distribution ratio between a front wheel friction braking torque and a rear wheel friction braking torque while controlling the value of a rear wheel regenerative braking torque not to exceed a value corresponding to the first reference deceleration. In this case, a rear wheel regenerative braking torque in the second section may have a constant value. According to an embodiment of the present disclosure, the controller unit 100 may control an amount of increase in a rear wheel friction braking torque and an amount of increase in a rear wheel regenerative braking torque with respect to a required deceleration to have a constant ratio. According to an embodiment of the present disclosure, the controller unit 100 may determine a distribution ratio between a front wheel friction braking torque and a rear wheel friction braking torque, seeking to enable the rear wheel friction braking torque to have a value equal to or greater than the value of amplitude. The amplitude refers to how much a rear wheel friction braking torque changes for a predetermined time when the controller unit 100 performs the wheel lock prevention control.

Since the third section may have a very large amount of required deceleration, the controller unit 100 may not apply a rear wheel regenerative braking torque for safety in the third section. That is, the controller unit 100 may distribute only a friction braking torque to front and rear wheels of a vehicle. When only a friction braking torque is distributed, it may be possible to control the braking torque easily during the wheel lock prevention control performed according to the command of the controller unit 100, thereby effectively preventing locking of wheels and enhancing safety during braking.

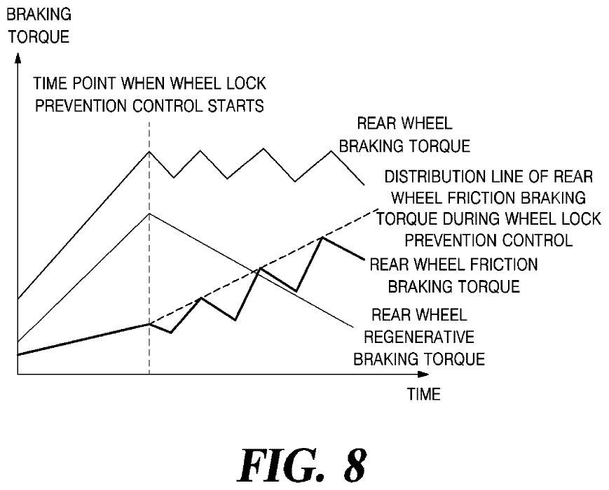

FIG. 8 is a graph showing how braking torque changes over time when the controller unit 100 starts the wheel lock prevention control according to an embodiment of the present disclosure.

Referring to FIG. 8, a rear wheel braking torque may be the sum of a rear wheel regenerative braking torque and a rear wheel friction braking torque. Both the rear wheel regenerative braking torque and the rear wheel friction braking torque may increase until the controller unit 100 starts the wheel lock prevention control, but, after the controller unit 100 starts the wheel lock prevention control, the rear wheel regenerative braking torque may decrease while the rear wheel friction braking torque may increase. According to an embodiment of the present disclosure, when performing the wheel lock prevention control, the controller unit 100 may determine a distribution ratio between a front wheel friction braking torque and a rear wheel friction braking torque based on the amount of change in a rear wheel regenerative braking torque. According to an embodiment of the present disclosure, when performing the wheel lock prevention control, the controller unit 100 may determine a distribution ratio between a front wheel friction braking torque and a rear wheel friction braking torque, seeking the amount of reduction in a rear wheel regenerative braking torque per unit time equal to the amount of increase in the rear wheel friction braking torque per unit time.

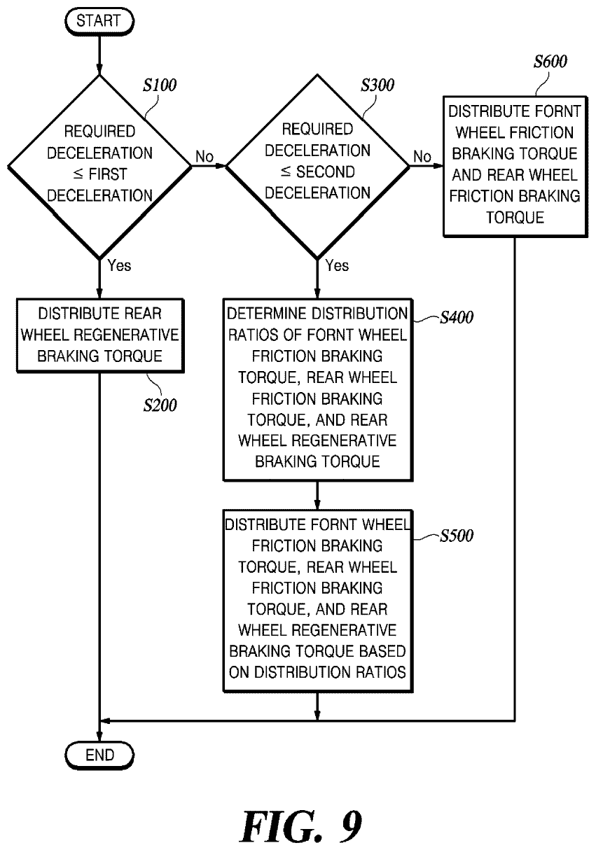

FIG. 9 is a flowchart of a method of controlling braking torque by an apparatus for controlling braking torque according to an embodiment of the present disclosure.

Referring to FIG. 9, the apparatus for controlling braking torque 1 according to an embodiment of the present disclosure may determine whether a required deceleration is less than or equal to the first reference deceleration at S100. When it is determined that the required deceleration is less than or equal to the first reference deceleration, the apparatus for controlling braking torque 1 may distribute a rear wheel regenerative braking torque to rear wheels at S200. Since a friction braking torque is not distributed to front wheels, the braking curve may be somewhat out of an ideal braking curve. When it is not determined that the required deceleration is less than or equal to the first reference deceleration, the apparatus for controlling braking torque 1 may determine whether the required deceleration is less than or equal to the second reference deceleration at S300. When it is determined that the required deceleration is less than or equal to the second reference deceleration, the apparatus for controlling braking torque 1 may determine distribution ratios of a front wheel friction braking torque, a rear wheel friction braking torque, and a rear wheel regenerative braking torque at S400. According to an embodiment of the present disclosure, in the process S400 where the apparatus for controlling braking torque 1 determines the distribution ratios of the front wheel friction braking torque, the rear wheel friction braking torque, and the rear wheel regenerative braking torque, it may be possible to change the distribution ratio of the rear wheel friction braking torque and the rear wheel regenerative braking torque while maintaining the predetermined distribution ratio of the front wheel braking torque and the rear wheel braking torque. In this case, the value of the front wheel friction braking torque may not change, and only the values of the rear wheel friction braking torque and the rear wheel regenerative braking torque may change. The apparatus for controlling braking torque 1 may distribute the front wheel friction braking torque, the rear wheel friction braking torque, and the rear wheel regenerative braking torque based on the determined distribution ratios at S500. When it is not determined that the required deceleration is less than or equal to the second reference deceleration, the apparatus for controlling braking torque 1 may distribute the front wheel friction braking torque and the rear wheel friction braking torque at S600. When the required deceleration is equal to or greater than the second reference deceleration, the apparatus for controlling braking torque 1 may perform only friction braking without performing regenerative braking because there is a high possibility of locking of wheels.

The apparatus for controlling braking torque 1 according to an embodiment of the present disclosure may further perform the wheel lock prevention control of repeatedly changing the amount of friction braking torque to prevent locking of wheels (not shown). In this case, the apparatus for controlling braking torque 1 may decrease a rear wheel regenerative braking torque and increase a rear wheel friction braking torque, and may determine the amount of change in the rear wheel friction braking torque per unit time based on the amount of change in the rear wheel regenerative braking torque per unit time.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. An apparatus for controlling braking torque for a vehicle, comprising:
a regenerative braking apparatus generating a regenerative braking torque to rear wheels;
a plurality of electro mechanical brakes (EMBs) generating a friction braking torque using an actuator; and
a controller that controls the regenerative braking apparatus and the plurality of EMBs, distributes a front wheel friction braking torque to front wheels, and distributes a rear wheel braking torque, which is a sum of a rear wheel friction braking torque and a rear wheel regenerative braking torque, to the rear wheels,
wherein the plurality of EMBs are respectively provided for each wheel of the vehicle so that a different friction braking torque is generated for each wheel, and
the controller changes a distribution ratio between the front wheel friction braking torque and the rear wheel friction braking torque.

2. The apparatus for controlling braking torque of claim 1, wherein the controller distributes only the rear wheel friction braking torque when a required deceleration is less than or equal to a first reference deceleration.

3. The apparatus for controlling braking torque of claim 1, wherein the controller distributes only the rear wheel regenerative braking torque and the front wheel friction braking torque when a required deceleration is equal to or greater than a first reference deceleration.

4. The apparatus for controlling braking torque of claim 1,
wherein the controller determines the distribution ratio based on an amplitude of the rear wheel friction braking torque when a required deceleration is equal to or greater than a first reference deceleration and wheel lock prevention control is not performed,
while performing the wheel lock prevention control, the controller repeatedly changes an amount of a friction braking torque to prevent locking of wheels, and
the amplitude refers to how much the rear wheel friction braking torque changes for a preset time when the wheel lock prevention control is performed.

5. The apparatus for controlling braking torque of claim 1, wherein, when performing wheel lock prevention control for repeatedly changing an amount of the friction braking torque to prevent locking of wheels, the controller reduces the rear wheel regenerative braking torque and increases the rear wheel friction braking torque, and the distribution ratio is determined based on an amount of change in the rear wheel regenerative braking torque per unit time.

6. The apparatus for controlling braking torque of claim 5, wherein the controller determines the distribution ratio so that an amount of reduction in the rear wheel regenerative braking torque per unit time equal to an amount of increase in the rear wheel friction braking torque per unit time.

7. The apparatus for controlling braking torque of claim 1, wherein the controller distributes only the front wheel friction braking torque and the rear wheel friction braking torque when a required deceleration is equal to or greater than a second reference deceleration.

8. A method of controlling braking torque for a vehicle, comprising:
a first process of determining whether a required deceleration is less than or equal to a first reference deceleration;
a second process of distributing a rear wheel regenerative braking torque when it is determined that the required deceleration is less than or equal to the first reference deceleration;
a third process of determining whether the required deceleration is less than or equal to a second reference deceleration when it is determined that the required deceleration is greater than the first reference deceleration;
a fourth process of determining distribution ratios of a front wheel friction braking torque, a rear wheel friction braking torque, and the rear wheel regenerative braking torque when it is determined that the required deceleration is less than or equal to the second reference deceleration;
a fifth process of distributing the front wheel friction braking torque, the rear wheel friction braking torque, and the rear wheel regenerative braking torque based on the distribution ratios; and
a sixth process of distributing the front wheel friction braking torque and the rear wheel friction braking torque when it is determined that the required deceleration is greater than the second reference deceleration.

9. The method of controlling braking torque of claim 8, wherein, in the fourth process, a distribution ratio between the rear wheel friction braking torque and the rear wheel regenerative braking torque is changed while a predetermined distribution ratio between a front wheel braking torque and a rear wheel braking torque is maintained.

10. The method of controlling braking torque of claim 8, further comprising a seventh process of performing wheel lock prevention control for repeatedly changing an amount of a friction braking torque to prevent locking of wheels,
wherein, in the seventh process, the rear wheel regenerative braking torque is reduced while the rear wheel friction braking torque is increased and an amount of change in the rear wheel friction braking torque per unit time is determined based on an amount of change in the rear wheel regenerative braking torque per unit time.
